(19) United States
(12) Patent Application Publication
(10) Pub. No.: US 2009/0030750 A1
(43) Pub. Date: Jan. 29, 2009

(54) BUSINESS INTERACTION SIMULATION SYSTEM FOR TRAINING

(75) Inventors: Georges Roberge, Sherbrooke (CA); Jean-Rene Bouchard, Pont-Rouge (CA)

Correspondence Address: BERESKIN AND PARR, 40 KING STREET WEST, BOX 401, TORONTO, ON, M5H 3Y2, CA

(73) Assignee: GROUPE CONSEIL JMA INC., Pont-Rouge (CA)

(21) Appl. No.: 11/829,171

(22) Filed: Jul. 27, 2007

(51) Int. Cl. G06Q 99/00

(52) U.S. Cl. 705/7

(57) ABSTRACT

The present invention relates to a method for a business interaction simulation for the purpose of training and evaluation. According to one aspect of the solution, the business interaction simulation allows participants to simulate business interactions in more than one politico-socio-economic environment. According to another aspect of the solution, the business interaction simulation allows participants to simulate business interactions with an identified institution that operates in at least one politico-socio-economic environment.

### FIELD OF THE INVENTION

The present invention relates to a simulation system that allows participants to simulate business interactions based on real life practices for training.

### BACKGROUND OF THE INVENTION

In present business practices, industrial globalization is a predominant factor that influences business decision makers. Although industrial globalization might seem at first hand beneficial to companies that want to expand or move their business to another region, it can require in some instances substantial adjustments. As the culture, norms, regulations and practices in different countries can change from one another, new business investors have a greater chance to make mistakes due to misinformation and maladapted business decisions. As a matter of fact, new business investors despite their experience might not be aware of the most efficient and profitable way of establishing and maintaining a business in a foreign country. Ideally, the ways of making business in a given country should be taught to prospective business settlers.

Conventionally, business schools and business programs normally provide classes where teachers dispense material as students listen and take notes with the aim of passing an exam. Consequently, in academia, students are rarely learning from their own experience and mistakes. In principal, learning from past experience and mistakes is however considered a way of learning that is much more efficient and longer lasting. Ways of transferring knowledge in business schools are however changing; students are allowed to experiment with different business situations and to learn from the experiment. With the help of software programs, students participate as actors in a simulation of a given business situation.

Some software programs such as described in United States Published Application 2006/0064352A1: “Strategic Business Simulation” and U.S. Pat. No. 6,931,365B1: “Industry Simulation Environment” can be useful tools for students to learn from. In published application 2006/0064352A1 a given market situation common to all players is simulated. Although the simulation can handle business interactions between many countries, the participants must follow predetermined business rules that are common to all regardless of the politico-socio-economic reality of the country. Such a simulation is a limited learning experience as in the real world, business rules change and vary from one country to another. This simulation does not provide prospective business people possibilities to learn about the cultural and politico-socio-economic challenges that they might encounter when establishing business in a given country.

In U.S. Pat. No. 6,931,365B1, on the other hand, a solution is presented to model a global economy by allowing the dynamic configuration of business rules. Several artificial agents are programmed to mimic human behavior and adapt to dynamically configurable business rules. In this case the business rules are also preprogrammed, they however expose the player to a variety of business rules that model the real world. It remains, nevertheless, a model that is developed with a pre-sampled set of information. A pre-sampled set of information cannot truly reflect the actual cultural and politico-socio-economic challenges of a given country for prospective business people.

In a prior system developed by the current inventor, business interactions are simulated with real participants only. Each participant plays a predetermined role that can either be a role that manages a business or a role that is a banker. The participant playing the role of the banker is also a banker in real life and assumes the role of a banker by applying the same interaction practices as he would in real life. However, the simulation takes place in only one politico-socio-economic environment. This simulation system does not provide prospective business people possibilities to learn about the cultural and politico-socio-economic challenges that they might encounter when establishing a business in a foreign country.

### SUMMARY OF THE INVENTION

The present solution relates to a method that allows participants to simulate business interactions with a defined simulation context for training and evaluating business interactions.

In one embodiment of the solution, the business interactions take place in more than one politico-socio-economic environment. The solution includes appointing at least one decision-making role for at least one virtual business entity to at least one participant. Similarly, the solution includes appointing at least one politico-socio-economic reference role for at least one virtual institution to at least one other participant.

According to another embodiment of the solution, the politico-socio-economic reference role is for an identified virtual institution. In this case, the business interactions take place in at least one politico-socio-economic environment.

In both embodiments of the solution, the decision-making role is subjected to rules of the corresponding politico-socio-economic environment. Similarly, the at least one politico-socio-economic reference role is subjected to rules of the corresponding politico-socio-economic environment.

The solution further includes establishing a communication link to perform or negotiate at least one business interaction between the at least one decision-making role and the at least one politico-socio-economic reference role of a politico-socio-economic environment. The business interaction takes place according to the rules of the corresponding politico-socio-economic environment.

Furthermore, according to another embodiment of this solution, a negotiation takes place between at least two decision-making roles. Additionally, according to another embodiment of this solution a purchase of information or of a service is considered as a business interaction.

In all embodiments of the solution, the decisions are made through the business interactions and through solutions discovered by the decision-making role. Consequently, decision parameter values are updated at each round and are processed to generate at least a financial report. For training and evaluation purposes, the at least one report is reviewed.

### BRIEF DESCRIPTION OF THE DRAWINGS

These and other features of the present solution will become more apparent from the following description in which reference is made to the apparent drawings wherein:

FIG. 1 is a flowchart diagram of a method for business interaction simulation, in accordance with an embodiment of the invention;

FIG. 2 is an information flow diagram that describes the interactions between instances, in accordance with an embodiment of the invention;

FIG. 3 is an association diagram that describes the relationship between instances, in accordance with an embodiment of the invention;

FIG. 4a is a description of a simulation context, in accordance with an embodiment of the invention;

FIG. 4b is a user interface to configure simulation context, in accordance with an embodiment of the invention;

FIG. 5 is a data flow diagram of a system for business interaction simulation, in accordance with an embodiment of the invention;

FIG. 6 is a network of systems for business interaction simulation, in accordance with an embodiment of the invention;

FIG. 7 is a user interface for operating the system for business interaction simulation, in accordance with an embodiment of the invention;

FIG. 8 is a balance sheet from the system for business interaction simulation, in accordance with an embodiment of the invention;

FIG. 9a is a result sheet from the system for business interaction simulation, in accordance with an embodiment of the invention;

FIG. 9b is a result sheet with additional information from the system for business interaction simulation, in accordance with an embodiment of the invention.

### DETAILED DESCRIPTION OF THE INVENTION

The present solution relates to a business interaction simulation method. More precisely, the business interaction simulation method allows participants to simulate business interactions in multiple foreign environments. The business interaction simulation method requires at least two types of participants. The first type of participant is the participant that wants to experiment the establishment or management of a business in a foreign environment. In the simulation, this type of participant is given a decision-making role for a virtual business entity. The simulation, allows decision-making role participants to make decisions for a virtual business entity located in a selected foreign environment. This way, the decision-making role participant learns about the rudiments of establishing or managing the business in the foreign environment. Moreover, the decision-making role participant learns from his decision-making behavior as to improve himself afterwards. Furthermore, the simulation can be a useful evaluation method and system to evaluate employees or potential candidates. Contrary to its prior art, this method exposes the virtual business entity participants to virtual institutions that are represented by the second type of participant: a real cultural and politico-socio-economic reference person or group of people. It is the interactions between the participants of virtual business entities and the participants of virtual institutions that give valuable insight to the participants when confronted to a similar situation. Furthermore, the interactions between the participants of virtual business entities and the participants of virtual institutions give valuable insight on the actual business culture and politico-socio-economic realities that are to be expected.

According to an embodiment of this method, a method to make the business interaction simulation is described. The method comprises a group of configuration steps that consist of selecting an environment step, setting a cultural and politico-socio-economic reality step and setting a simulation context step. The method comprises, furthermore a group of subjugating steps that consist of subjecting a virtual business entity and a virtual institution to cultural and politico-socio-economic rules. Moreover, the subjugating steps consist of appointing roles to participants. Following the subjugating steps, a business interaction step and decision-making step are described. The method concludes with a step that consists of an evaluation step. The steps can be interchanged and additional steps may be interposed. Moreover, these steps can be revisited numerous times in a single simulation. The following describes in greater detail the method of the business interaction simulation.

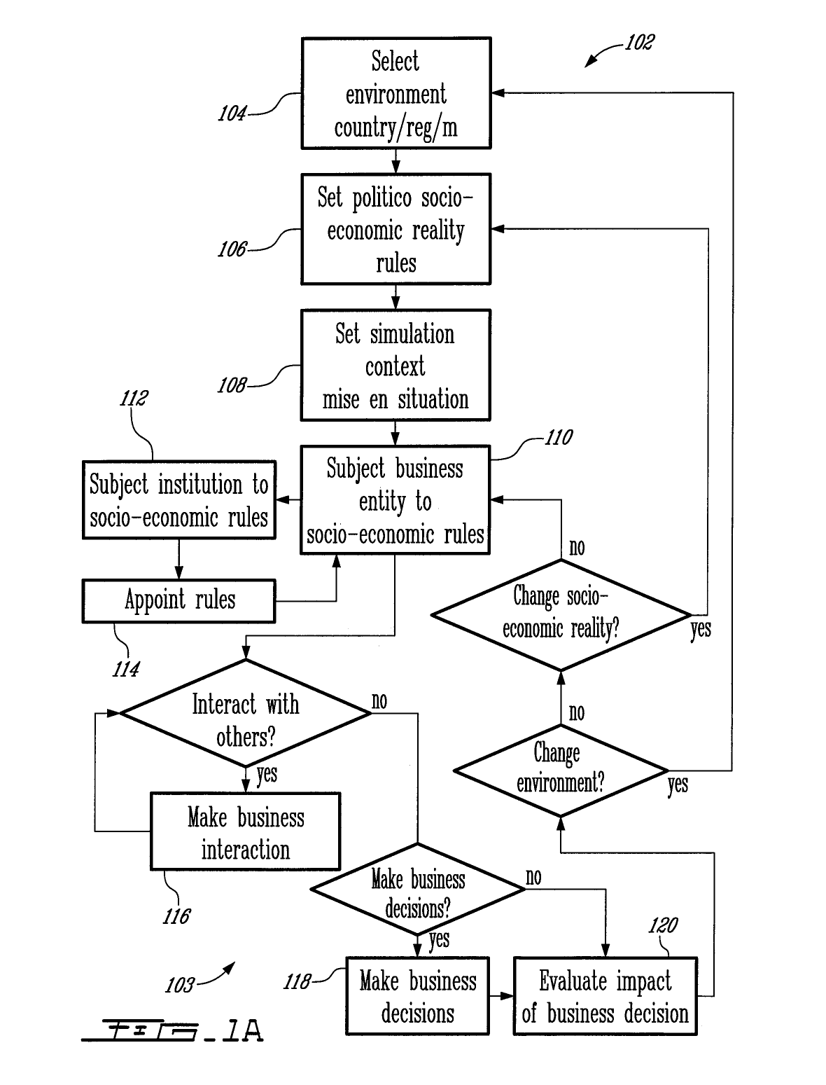

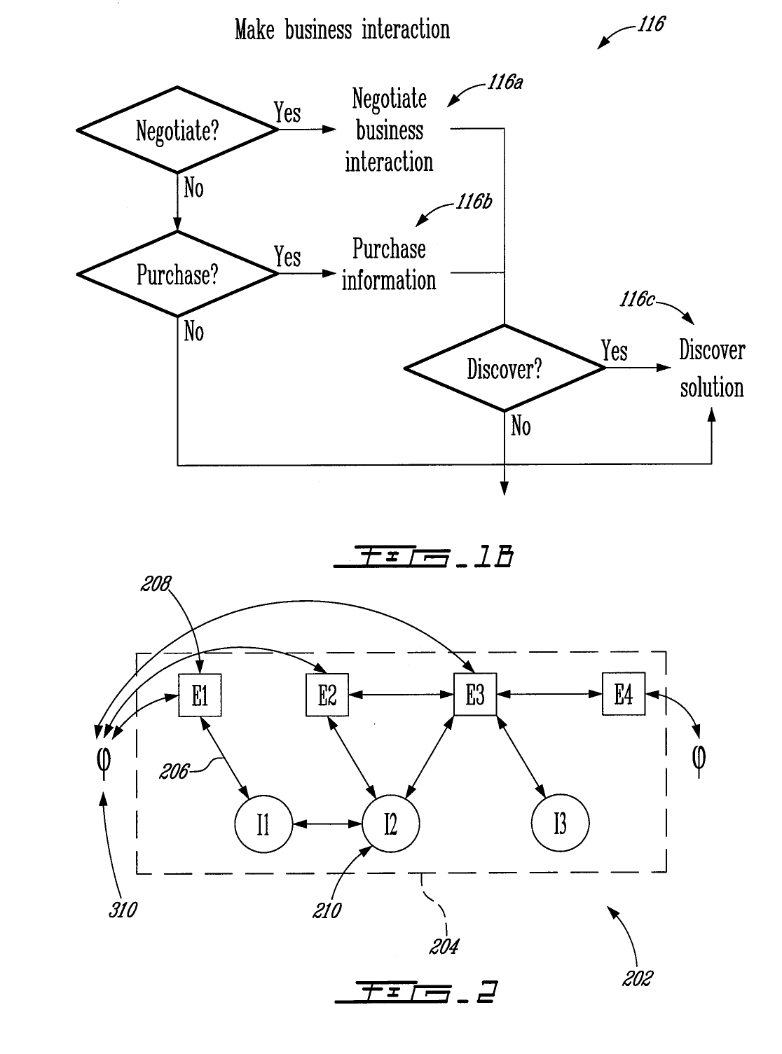

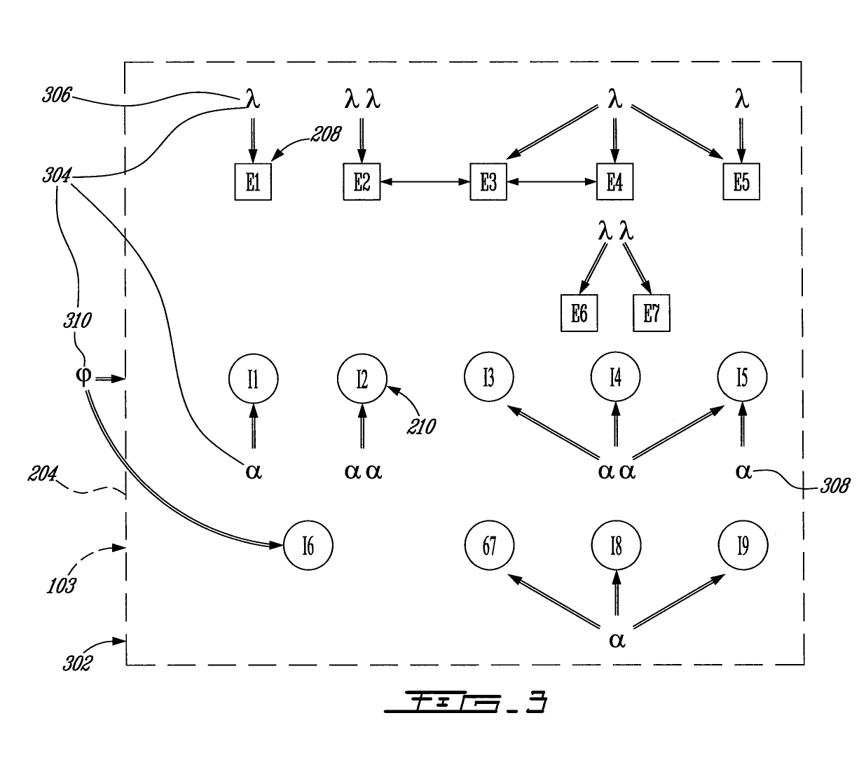

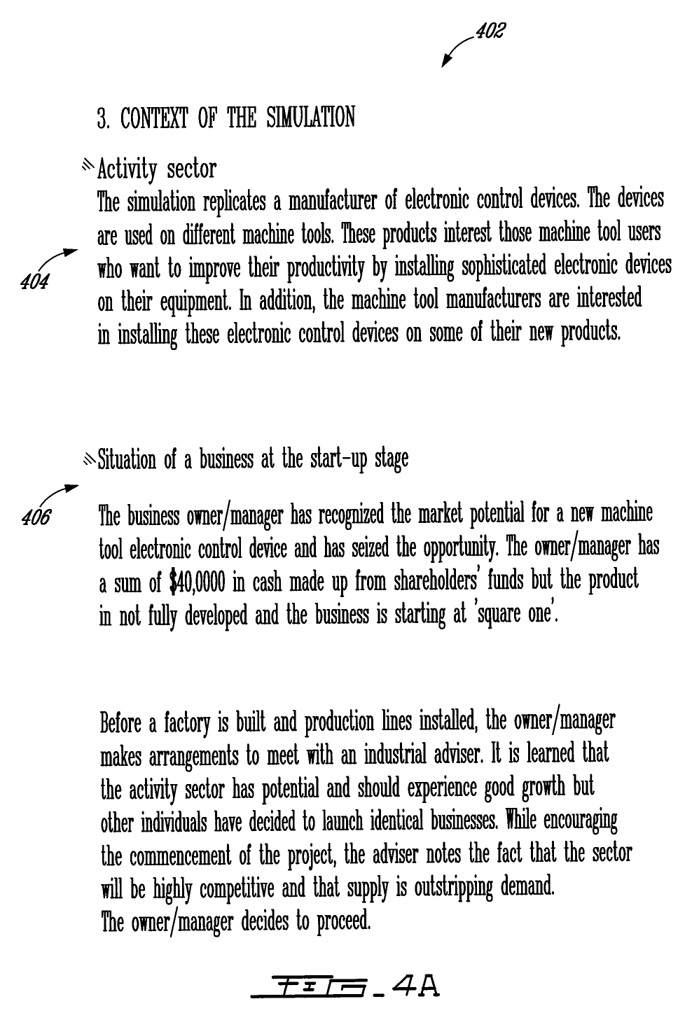

Presented in FIG. 1a is a business interaction simulation method 102. The method 102 includes sequential steps and is executed recursively. The first step of the method 102 is a configuration step and consists of a “select environment” step 104. Concurrently presented in FIG. 2, is a business interactions scenario 202. The business interactions scenario 202 includes an environment 204 that is selected through the “select environment” step 104. The “select environment” step 104 consists of selecting the predetermined environment 204 or the environment 204 from a predetermined list of environments 204. The selected environment 204 is a region, a country or any defined area bound by a cultural and politico-socio-economic reality. Furthermore, multiple environments 204 are selected when a simulation takes place across multiple environments 204.

Following the “select environment” step 4, as further presented in FIG. 1a, is another configuration step that is a “set politico-socio-economic reality” step 106. The “set politico-socio-economic reality” step 106 consists of setting the accurate politico-socio-economic reality. The accurate politico-socio-economic reality is set according to the selected environment 204, as concurrently presented in FIG. 2. Moreover, the “set politico-socio-economic reality” step 106 includes setting rules, regulations and policies that influence business interactions 206 in the selected environment 204. In other words, the “set politico-socio-economic reality” step 106 takes into consideration local customs, local available technologies or any other cultural and politico-socio-economic element that might influence the business interactions 206 in the chosen environment 204.

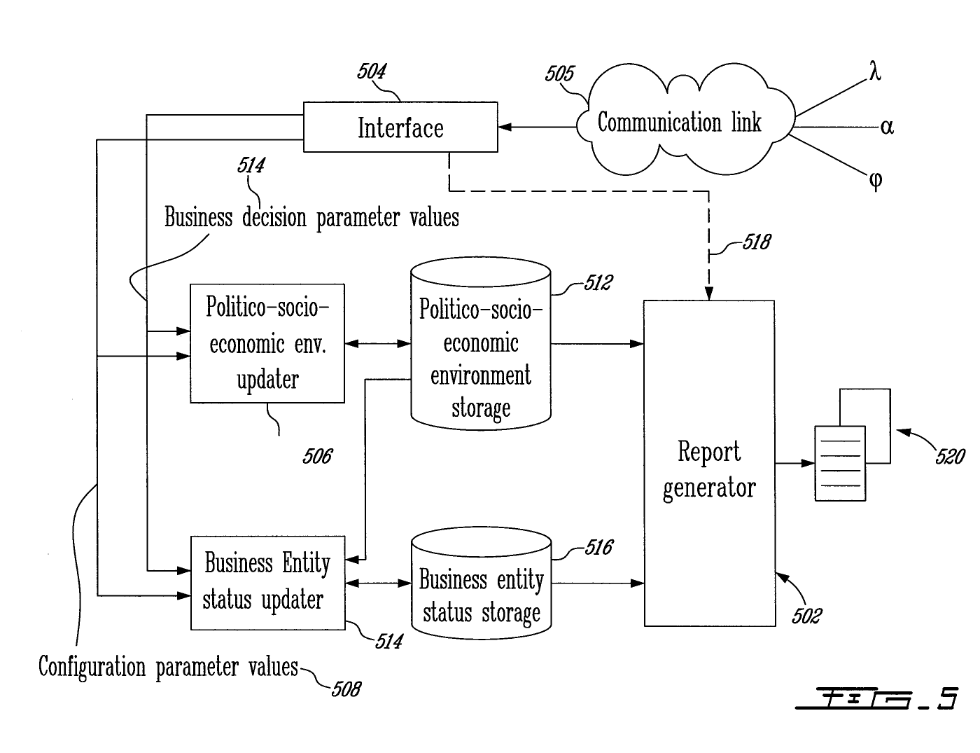

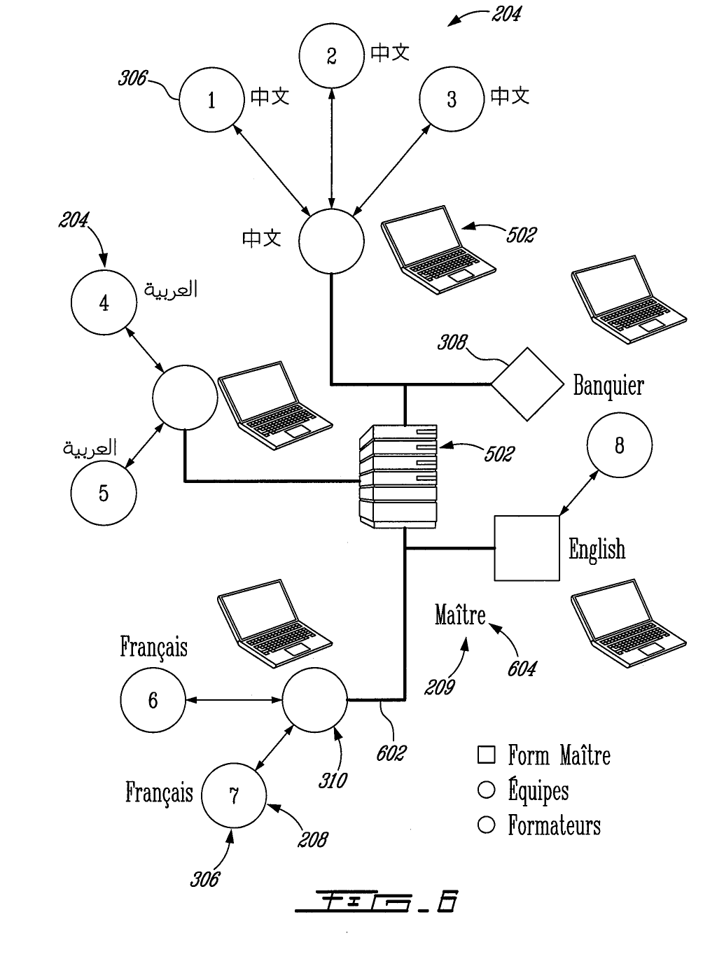

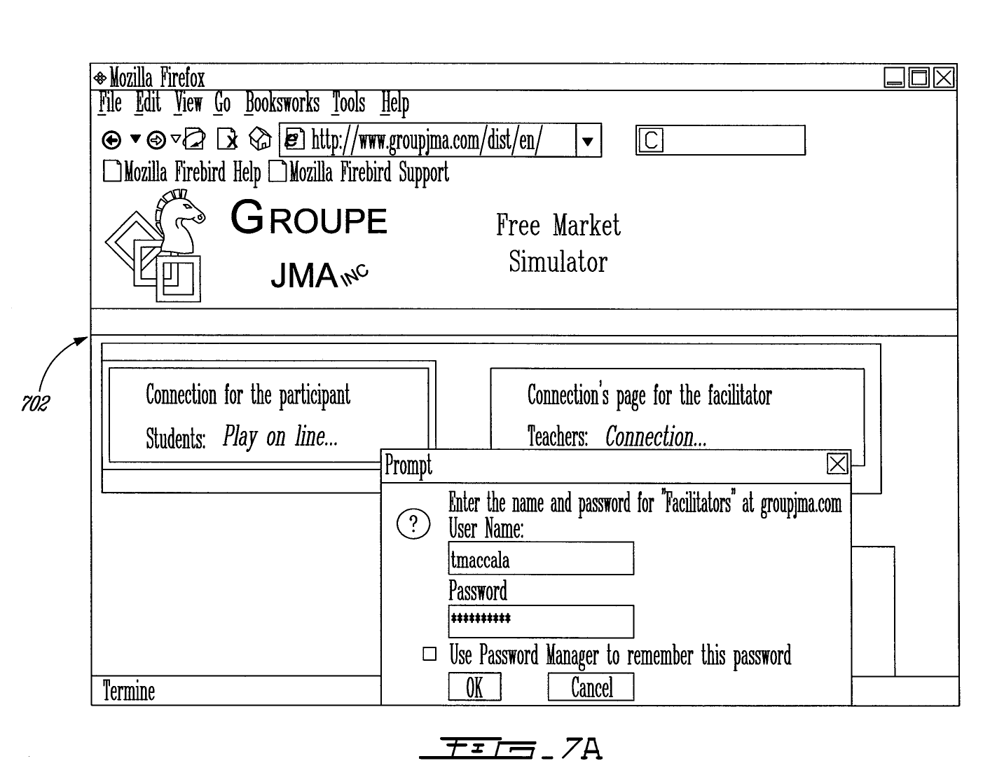

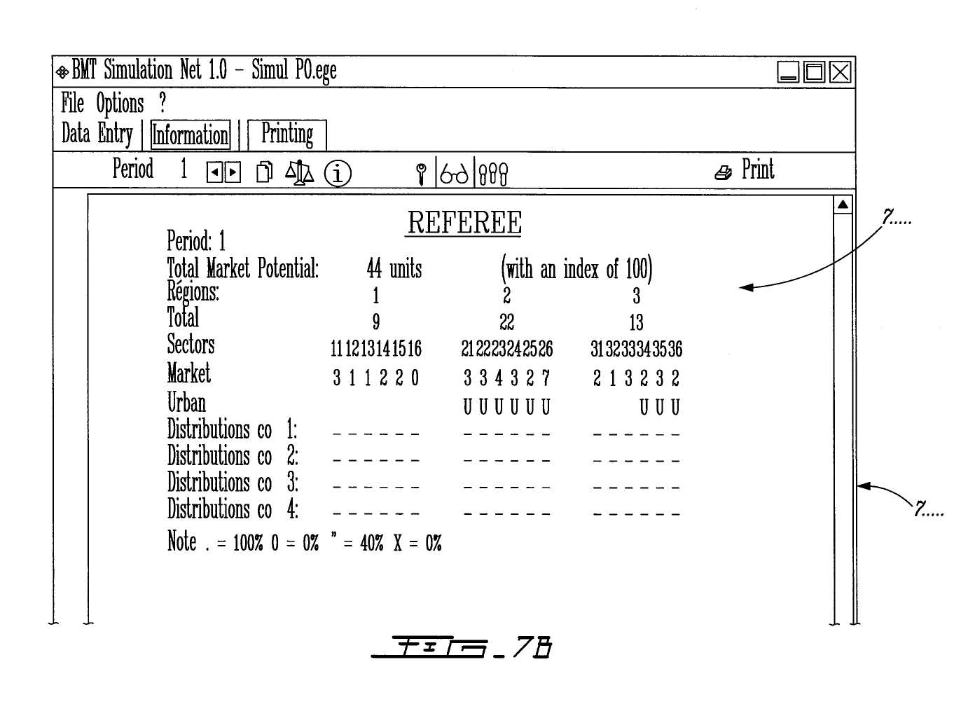

As further presented in FIG. 1a, in an embodiment of this method, is one last configuration step that follows the “set politico-socio-economic reality” step 106 which consists of the “set simulation context” step 108. Concurrently presented in FIG. 4a is an embodiment of the method that displays a simulation context 402. The “set simulation context” step 108 consists of setting the wanted simulation context 402. The “set simulation context” step 108 takes into consideration the previously set politico-socio-economic reality and the previously selected environment 204, as concurrently presented in FIG. 2. The purpose of the simulation context 402 is to expose an aspect or several aspects of the business interactions 206. Moreover, the simulation context 402 addresses factors that are internal or external to virtual business entities 208.

An internal factor to the virtual business entities 208 is a practice area 404. As presented in an embodiment of this method, the simulation context 402 is established by selecting the practice area 404 for the virtual business entity 208. In this embodiment, the practice area 404 that has been selected is the production of electronic command tools for selling to manufacturers. As people skilled in the art will understand, the selected practice area 404 may differ from one simulation to another. As a mater of fact, the practice area 404 of the virtual business entity 208 consists of selling, producing, distributing or managing specific goods or services. Alternatively, the practice area 404 of the virtual business entity 208 consists of a combination of the above-mentioned practice areas 404.

Another internal factor to the virtual business entity 208 is an actual state 406. As presented in an embodiment of this method, the simulation context 402 is also established by selecting the actual state 406 of the virtual business entity 208. The actual state 406, describes a business in terms of maturity level and its financial state. In this embodiment, the actual state 406 of the virtual business entity 208 that is selected is at a start-up stage with a sum of 400 000$ of cash at hand. As people skilled in the art will understand, other levels of actual states 406 are possible. Consequently, any given maturity level and financial state of the virtual business entity 208 may be selected as an actual state 406.

Following are some external factors that are set in the simulation context 402. As presented in an embodiment of this method, the simulation context 402 is also established by selecting a present economical situation of the environment 204. In this embodiment, as presented in FIG. 4b, an economic index 452 representing an economical situation of the environment 204 is set for different levels of recession or growth periods. Moreover, according to an embodiment of this method, the simulation context 402 is also established by setting a market potential index 454.

Further presented in FIG. 4a and concurrently presented in FIG. 2, according to an embodiment of this method, the simulation context 402 is also established by selecting the available virtual institutions 210. Virtual institutions 210 are all institutions or organizations that are capable of giving financial help or offering a service to the business entities 208. In an embodiment of this method, the virtual institutions 210 are financial institutions such as banks and other organizations such as governmental institutions. In another embodiment of this method, the virtual institution 210 is a consultancy service organization.

Further presented in FIG. 4b and concurrently presented in FIG. 4a and FIG. 2, according to an embodiment of this method, the simulation context 402 is also established by selecting the number 456 of virtual business entities 208 and the number 458 of virtual institutions 210 that are present in the simulation. As people skilled in the art will understand, it is possible that only one virtual business entity 208 and only one virtual institution 210 coexist in a single or multiple environments 204. It is furthermore possible that a single virtual business entity 208 and several virtual institutions 210 coexist in a single or multiple environments 204. Such a simulation contexts 402 is prevalently used for evaluation purposes.

Furthermore presented in FIG. 2, as people skilled in the art will understand, it is possible that several virtual business entities 208 and several virtual institutions 210 coexist in a single or multiple environments 204. It is moreover possible that several virtual business entities 208 and only one virtual institution 210 coexist in a single or multiple environments 204. Such simulation contexts 402, as presented in FIG. 4a, is prevalently used for training purposes or gaming purposes.

The above-mentioned configuration steps are furthermore removable, interchangeable or combinable. Moreover, people skilled in the art would also understand that in some cases additional configuration steps are interposable.

According to an embodiment of this method, the following describes the subjugating steps. It is to be noted that although the subjugating steps are presented in this work as a distinct group of steps, as people skilled in the art will understand, the subjugating steps are combinable to any other group of steps and don't necessarily need to follow the configuration steps.

According to an embodiment of this method, the first subjugating step is a “subject business entity to politico-socio-economic rules” step 110, as presented in FIG. 1a. As concurrently presented in FIG. 2, the “subject business entity to politico-socio-economic rules” step 110 consists to impose rules onto the virtual business entities 208 that are defined by the “set simulation context” step 108. Moreover, virtual business entities 208 must also operate by the rules of the cultural and politico-socio-economic reality that are set at the “set politico-socio-economic reality” step 106.

Following the “subject business entity to politico-socio-economic rules” step 110, an additional subjugating step follows. As further presented in FIG. 1a according to an embodiment of this method, is a “subject institutions to politico-socio-economic rules” step 112. As concurrently presented in FIG. 2, the “subject institutions to politico-socio-economic rules” step 112 consists to impose rules onto the virtual institutions 210 that are defined in the “set simulation context” step 108. Moreover, the virtual institutions 210 must also operate by the rules of the cultural and politico-socio-economic reality that are set at the “set politico-socio-economic reality” step 106.

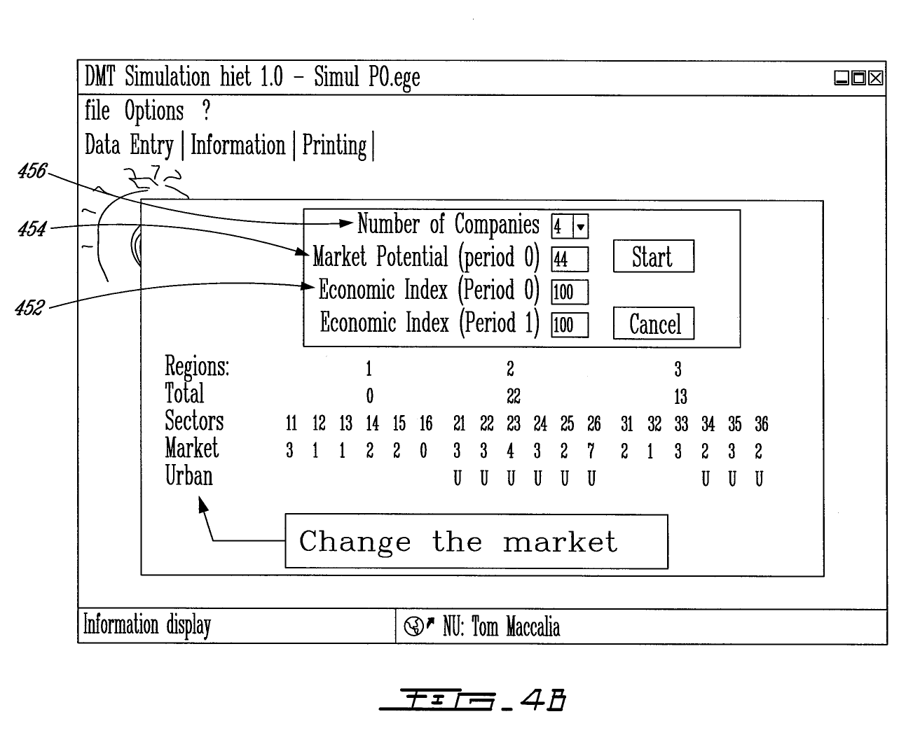

A last subjugating step, as presented in FIG. 1a according to an embodiment of this method, is an “appoint roles” step 114. Concurrently, in FIG. 3, a role appointment scenario 302 that consists of appointing roles to participants 304 is presented. The “appoint roles” step 114 consists of appointing roles to participants 304 either to manage a virtual business entity 208, to manage a virtual institution 210 or optionally to coordinate the simulation. Participants 304 are appointed a decision-making role 306 when assigned to manage a virtual business entity 208. The decision-making role 306 is assigned to participants 304 that are players or to participants 304 that require training or evaluating.

In an embodiment of this method, several participants 304 are appointed to manage a single virtual business entity 208. As a result several decision-making roles 306 are assigned to manage a single virtual business entity 208. In this case, the decision-making roles 306 for a single virtual business entity 208 work as a team to create a single set of decisions. Just like in a real business where several people are in a decision making position, the team is brought to discuss ideas and find ways amongst each other to come to a consensus. This kind of exchange in a team of decision-making roles 306, although challenging, is an enriching experience as participants 304 learn from each other. It is a furthermore valuable method to learn how to work as a team.

In another embodiment of this method, one participant 304 or a team of participants 304 is appointed to manage several virtual business entities 208. Although the different virtual business entities 208 are in competition with each other, the decision-making role 306 for these virtual business entities 208 must answer to the best interest of each virtual business entity 208 while taking into consideration the overall virtual business entities' 208 interests as a whole. Such a role appointment is given for more experienced participants 304 that have already acquired the capabilities to manage a single virtual business entity 208.

In another embodiment of this method, a combination of ways to appoint participants 304 to manage virtual business entities 208 is used during the simulation. This is useful if the participants 304 have different levels of experience or if the participants 304 want to expose themselves to different situations.

Further presented in FIG. 3, the participants 304 are appointed a politico-socio-economic reference role 308 when assigned to manage the virtual institution 210. The politico-socio-economic reference role 308 is assigned to participants 304 that are knowledgeable about the ways of making business interactions 206 in the selected environment 204, as concurrently presented in FIG. 2. These participants 304 are selected from a range of politico-socio-economic references such as bank managers, government officials, business management teachers, human resource consultants, or any person that has a good knowledge of the ways of making business interactions 206 in their assigned virtual institution's 210 environment 204.

In an embodiment of this method, the virtual institutions 210 are identified institutions that exist in real life. In this case, the politico-socio-economic reference role 308 behaves according to the identified institutions to which it has been assigned. This allows the decision-making role 308 participants 304 to learn how to interact with a given institution.

In an embodiment of this method, several participants 304 are appointed to manage one virtual institution 210. As a result several politico-socio-economic reference roles 308 are assigned to manage a single virtual institution 308. This kind of role appointment is useful when there are many more virtual business entities 208 then virtual institutions 308. Consequently, this assures a better responsiveness towards the virtual business entities 208.

In another embodiment of this method, the participant 304 or a team of participants 304 are appointed to manage several virtual institutions 210. Even when the different virtual institutions 210 are in competition with each other, the politico-socio-economic reference role 308 for these virtual institutions 210 must answer to the best interest of each virtual institution 210. Appointing roles in this fashion is prevalently used when there is a shortage of participants 304 with politico-socio-economic knowledge.

In another embodiment, a combination of ways to appoint participants 304 to manage virtual institutions 210 is used. This is useful if there are several types of virtual institutions 210 that require politico-socio-economic reference participants 304 with different knowledge. If the level of demand varies for each type of virtual institution 210, it might be required to vary the number of politico-socio-economic reference roles 308 appointed to the virtual institutions 210.

Further presented in FIG. 3, participants 304 are appointed a coordination role 310 when assigned to coordinate the simulation. The coordination role 310 is an optional role that is assumed by a single person or by a group of people. Moreover, the coordination role 310 assures the proper progression of the simulation. In an embodiment of this method, the coordination role 310 answers questions from other participants, supervises and enforces the rules of the simulation and provides the required communication links between participants 304.

As presented in FIG. 2 and concurrently in FIG. 3, in an embodiment of the present method, the coordination roles 310 are each dedicated to a specific group of virtual business entities 208. This is useful when several groups of participants 304 are remotely located. At least one participant 304 with the coordination role 310 is then placed in each location.

In another embodiment of the present method, as further presented in FIG. 2 and concurrently in FIG. 3, the participant 304 that has a coordination role 310 is assigned to manage a single or several virtual institutions 210. The participant 304, in this case must be knowledgeable about the ways of making business interactions 206 in the virtual institution's 210 environment 204. This practice is, for instance, suitable for simulations with a small group of participants 304.

The above-mentioned subjecting steps are furthermore removable, interchangeable or combinable. Moreover, people skilled in the art would also understand that in some cases additional subjecting steps might be interposed.

According to an embodiment of this method, the following describes three independent steps that come next. The steps consist of a business interaction step, a decision-making step and an evaluation step. It is to be noted that although these three steps are presented in this work as distinct single steps, people skilled in the art will understand that these three steps are combinable, removable, exchangeable, interchangeable or interposable with other steps or groups of steps.

Returning to FIG. 1a and FIG. 2 is presented the business interaction step, which is described in an embodiment of this method as an optional “make business interaction” step 116. The “make business interaction” step 116 consists of allowing virtual business entities 208 and virtual institutions 210 to make business interactions 206.

According to another embodiment of this method, additional forms of business interactions 206 take place such as business interactions 206 between several virtual business entities 208 or between several virtual institutions 210. The business interaction 206 consists of numerous types of interactions. As presented in FIG. 1b according to an embodiment of this method, the “make business interaction” step 116 involves a “negotiate business interaction” step 116a. People skilled in the art will recognize that a negotiation is a bilateral communication that concludes by an agreement or a disagreement. The negotiation consists of making an offer to which numerous counter-offers may follow and where finally, in the case of an agreement, an acceptance takes place. A negotiation may take place for various reasons, to get a loan from a bank, to get a subsidy, to make an investment, to get a wanted price for a purchase, to merge or acquire another company etc.

As further presented in FIG. 1b according to an embodiment of this method, the “make business interaction” step 116 involves a “purchase information” step 116b. People skilled in the art will recognize that a purchase of information may be done in a form of a service request. In this embodiment, information concerning the market in which the virtual business entity 208 of FIG. 2 is established or intends to establish may be purchased at a given price.

As further presented in FIG. 1b according to an embodiment of this method, the “make business interaction” step 116 involves a “discover solution” step 116c. The decision-making role 306 of FIG. 3 is encouraged to ask questions and to try to discover new ways to solve its problems as in the real world. The “discover solution” step 116c may occur following a “negotiate business interaction” step 116a or a “purchase information” step 116b. Consequently, the decision-making role 306, may discover a solution through a meeting or a business diner with a given politico-socio-economic reference role. In other words the decision-making role 306 is brought to discover by experimentation concepts or lessons that where unknown to him.

Further presented in FIG. 1a and FIG. 2 is the decision-making step, which is described in an embodiment of this method as an optional “make business decisions” step 118. The “make business decisions” step 118 consists of making various strategic business decisions adjusted to the environment 204. The mentioned business decision, is any kind of decision that affect sales, production, research and development, employment, government grants, bank loans, financials, quality of product, quality of service, etc.

The “make business decisions” step 118 may be a bilateral decision based on the “make business interaction” step 116. In this case, a decision is taken based on a conclusion of the business interaction 206 that took place in the same round or in the previous rounds. Alternatively, the “make business decisions” step 118 may be a unilateral decision that is not based on the “make business interaction” step 116. In this case, the decision-making role 306 makes a decision without any negotiation or purchase of information.

Further presented in FIG. 1a and FIG. 2 is the evaluation step, which is described in an embodiment of this method as an “evaluate impact of business decision” step 120. The “evaluate impact of business decision” step 120 consists of communicating to each virtual business entity 208 its results based on a given set of performance indicators. In an embodiment of this method, results are formulated in the form of a financial balance sheet and a client base information sheet. As presented in FIG. 3, in the case where the coordinator role 310 is present, the coordinator 310 has access to the evaluation of each virtual business entity 208.

Presented in FIG. 1a, according to an embodiment of this method, the “evaluate impact of business decision” step 120 is a concluding step to a round of the method 2. As presented in an embodiment of this method, a readjustment of the configuration steps take place after the evaluation step. However, people versed in the art will acknowledge that the readjustment of the configuration steps is also done at other moments of the simulation.

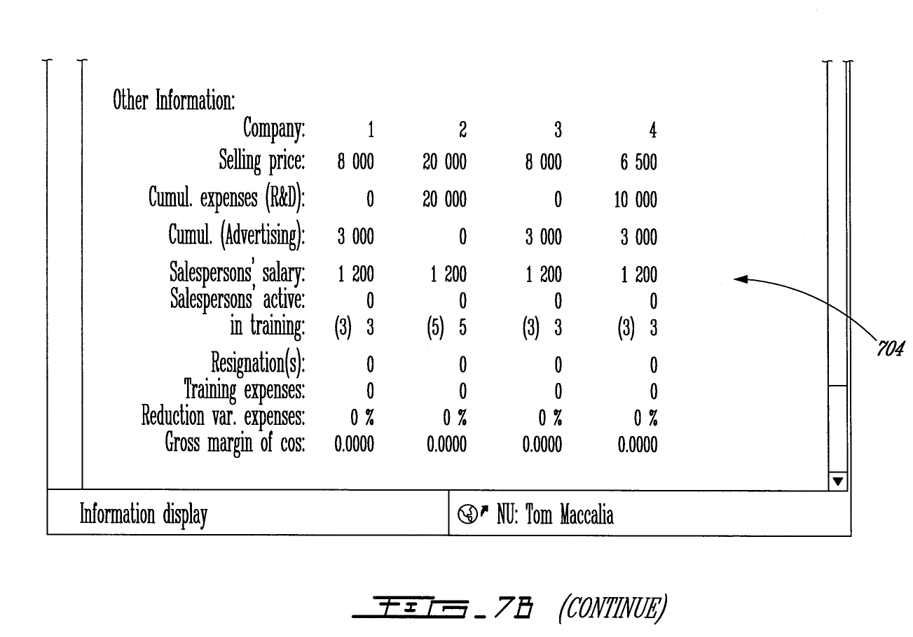

In FIG. 5, a business interaction simulation system 502 is presented. According to an embodiment of this solution, the system 502 consists of an interface 504, a politico-socio-economic environment updater 506, a business entity status updater 514 and a report generator 518. The interface 504 allows setting the environment, the politico-socio-economic reality and the simulation context of the simulation. The interface 504 furthermore allows capturing business decisions from participants 304 with the business decision-making role 306 for the virtual business entity 208 as concurrently presented in FIG. 3. The participants 304 access the interface 504 directly or indirectly through a communication link 505

The politico-socio-economic environment updater 506 updates the politico-socio-economic environment by consolidating an actual politico-socio-economic environment with configuration parameter values 508 or business decision parameter values 510. The new parameter values for the politico-socio-economic environment are stored in the politico-socio-economic environment storage 512.

The business entity status updater 514 updates the business entity status by consolidating an actual politico-socio-economic environment with configuration parameter values 508 or business decision parameter values 510. The new business decision parameter values 510 for the business entity are stored in the business entity status storage.

The report generator 518, takes into consideration the parameter values that have been stored in the politico-socio-economic environment storage 512 and the business entity status storage 516. A report 520 is generated for presentation to the concerned participant 304. People skilled in the art will understand that the report 520 is any type of report that presents the actual status of the business entity 208. The report 520 is either sent through a communication link 505 or is directly accessed by the participant.

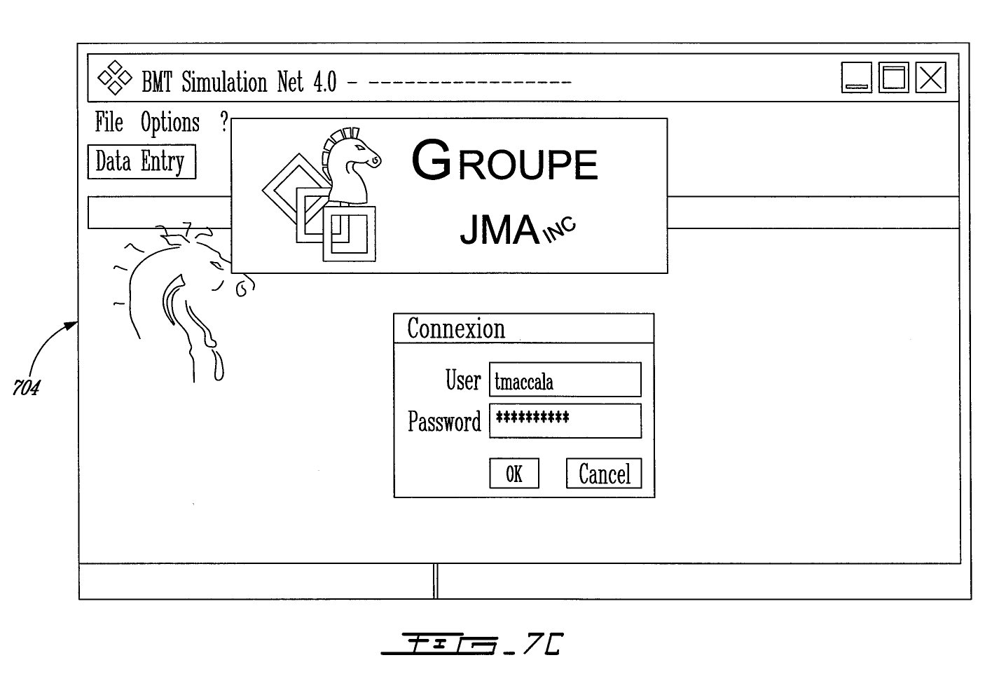

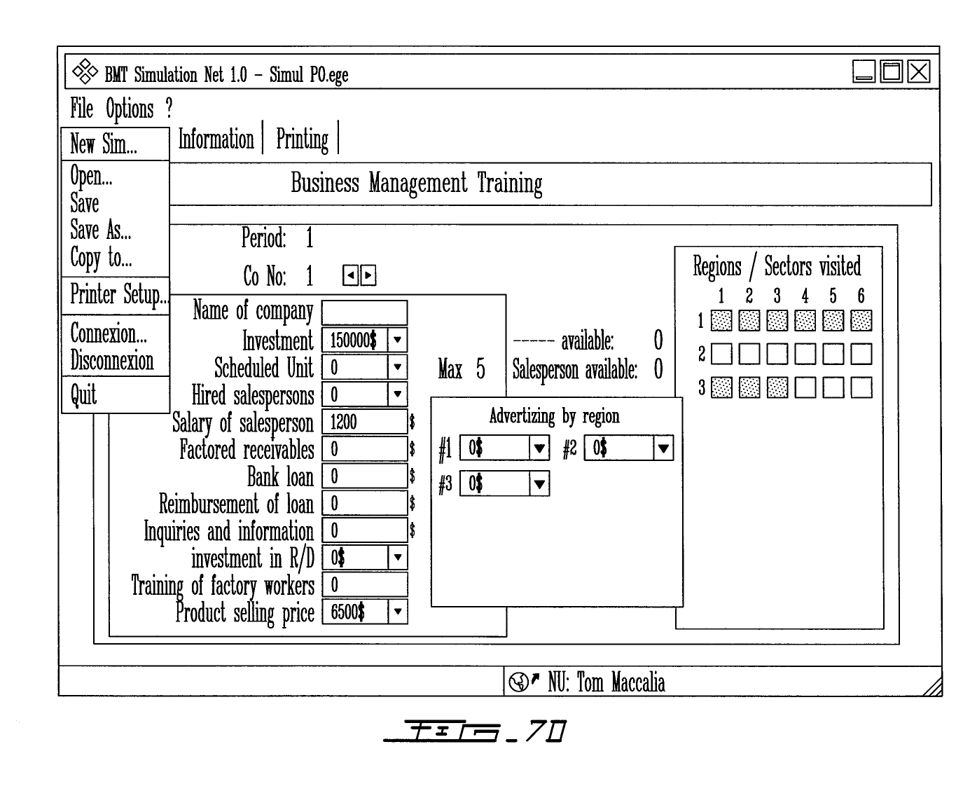

According to an embodiment of this solution, as presented in FIG. 6, multiple systems 502 are distributed in different environments 204 as concurrently presented in FIG. 3. The single participant 304 or group of participants 304 is located in multiple environments during the simulation. In this embodiment, although the participants are remotely located, the participants with the decision-making role 306 represent single virtual business entities 208 or multiple distinct virtual business entities 208 or a combination of both. In order to coordinate participants and to allow participants to communicate with each other, a communication link 505 is provided. It is understood that the communication link 505 is any mean of communication that is integrated with the system 502 or that is independent. Possible means of communication consist of phones, a chatting network system, a video conferencing network system or any other mean or combination of means of communicating.

As further presented in FIG. 6 and concurrently presented in FIG. 3, according to an embodiment of this solution, for each group of decision-making role 306, the coordinator 310 is located in the same environment 204. The decision-making roles 306 communicate to the coordinator 310 their business decisions. The coordinator 310 then inputs into the system 502 the business decisions for each virtual business entity 208 represented by a decision-making role 306 of the environment 204.

Presented in FIG. 6, according to another embodiment, the simulation takes place with participants 304 coming from different politico-socio-economic environments 204 and having different nationalities. Consequently, the coordination role 310 acts as an interface between participants of different nationalities to facilitate communication.

According to an embodiment of this solution, as presented in FIG. 6, a master coordinator 604 monitors all the virtual business entities 208 of each environment 204 and communicates changes to each coordinator 310. The master coordinator 604, communicates changes to each coordinator 310 concerning environment 204 changes, politico-socio-economic changes, simulation context 402 changes or any other pertinent changes, as concurrently presented in FIG. 4a. The master coordinator 604 also coordinates the coordinators 310 to assure consistency throughout the environments and communicates with the coordinator 310 for support issues.

According to an embodiment of this solution, as further presented in FIG. 6 and concurrently presented in FIG. 3, the coordinator role 310 or the master coordinator role 604 dispense an information session. The information session is dispensed in a brief manner before the start of the simulation. The purpose of the information session is to explain the method 102, as presented in FIG. 1a, to the other participants 304. Moreover, the information session also includes the rules of the simulation and the simulation context 402.

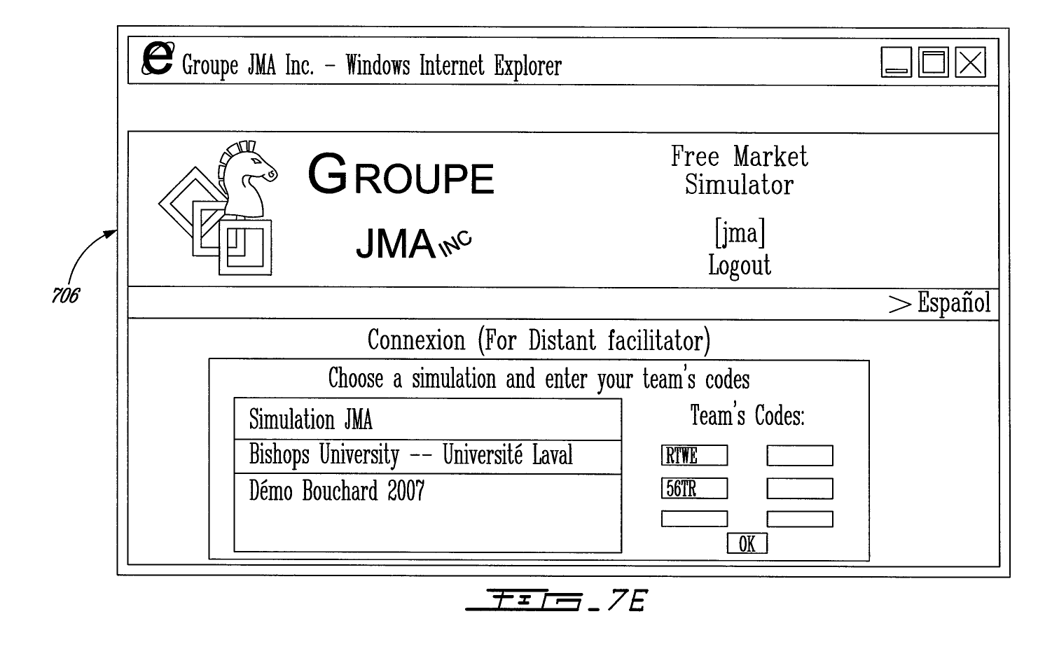

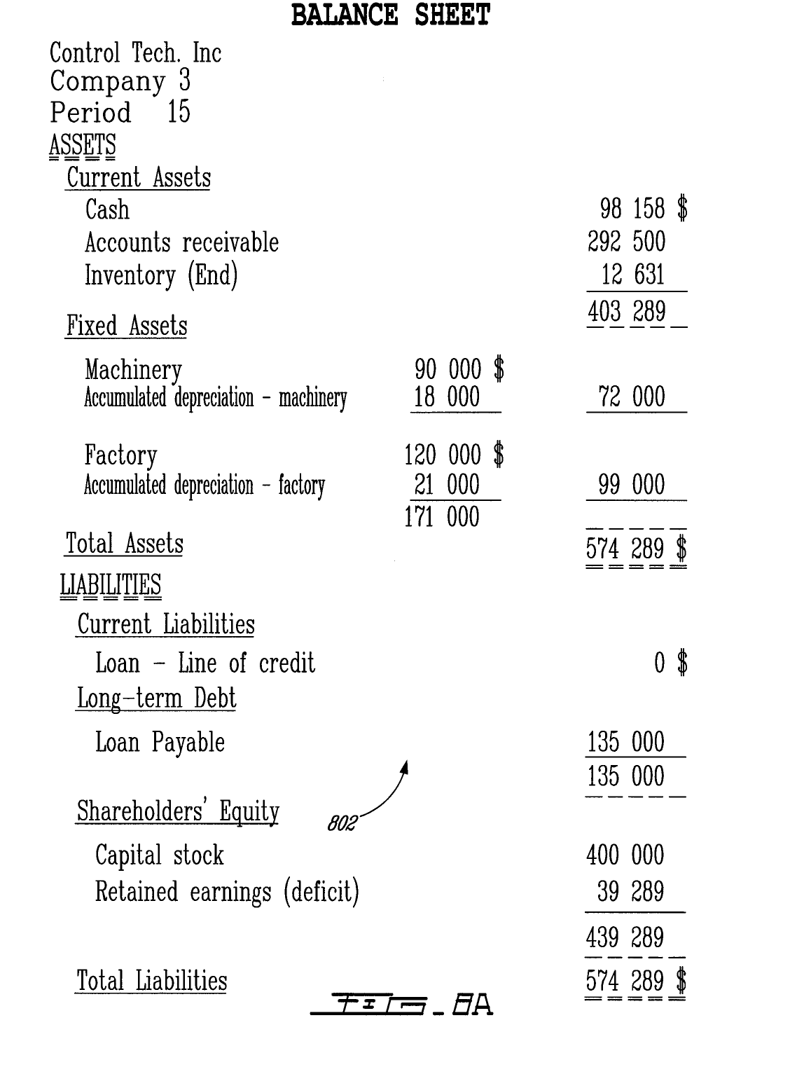

Moving on to FIG. 7, according to an embodiment of this solution, several snapshots of the user interface 702 are presented for the interface 504 and the report generator 518. The interface 504 and the report generator 518 allows the coordinator 310 to insert business decisions 510 and retrieve results 520 for the virtual business entities 208 it coordinates, as concurrently presented in FIG. 3 and FIG. 5. The user interface 702 consists of a connection interface 704 for the coordinator 310. In the case where several simulations are taking place, the coordinator 310 is requested to select the proper simulation through a simulation selection interface 706. The coordinator is also given the possibility to monitor the simulation through a monitoring interface 708.

According to an embodiment of this solution, the monitoring interface 708, presents an index of the market potential 710. The market potential 710 is furthermore detailed for each region a given virtual business entity 208 operates. Additional information 712 such as sales price, salaries, expenses or any other type of financial information is selected and made available to the virtual business entity 208. Although not presented in this embodiment, people skilled in the art will acknowledge that, in some instances, a presentation of statistic analysis results in the monitoring interface 708 or in another interface is possible.

According to an embodiment of this solution, a decision-making entry interface 714 is made available for the coordinator 310 to input for each virtual business entity 208 the business decisions 510 made by the decision-making role 310. Decisions concerning investment, production, employment, bank credit or any other selected business decisions 510 that is made by the decision-making role 306 for the virtual business entity 208 is entered. Although, according to this embodiment, it is the coordinator 310 that inputs the business decisions 510, people skilled in the art will acknowledge the possibility for the decision-making role 310 to enter directly his business decisions 510 in the system 502.

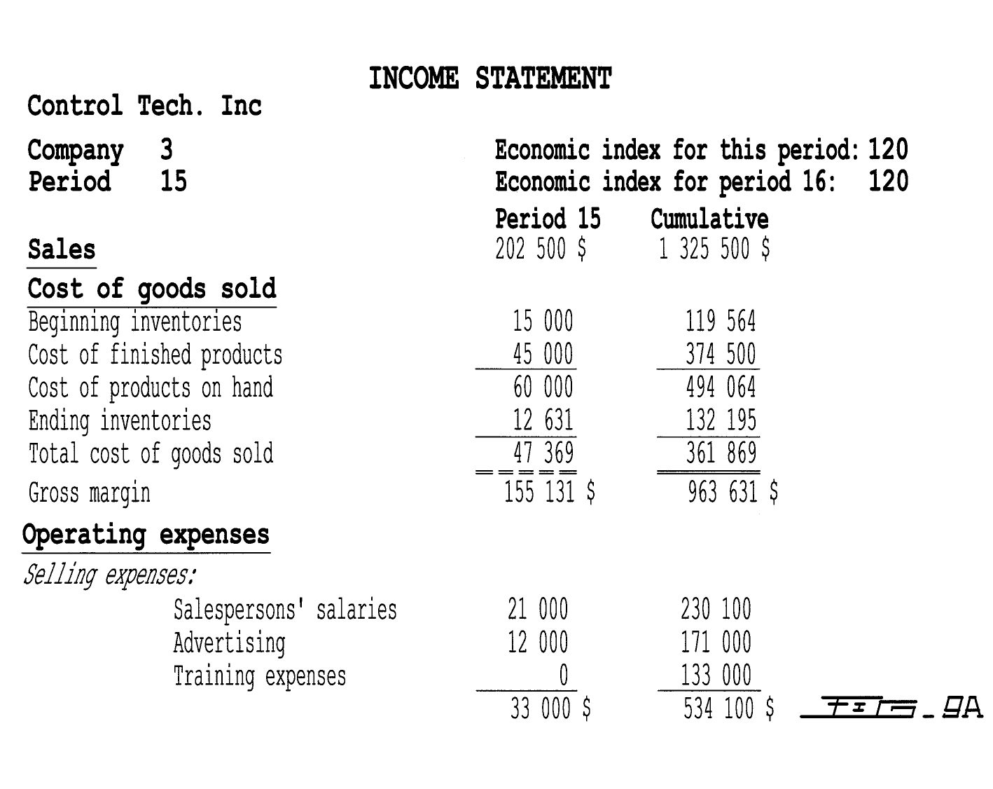

Moving onto FIG. 8, according to an embodiment of this solution, the report generator 518, presented in FIG. 5, generates a balance sheet 802. As concurrently presented in FIG. 3, the balance sheet 802 describes the active and the passive amounts for each virtual business entity 208. In this embodiment, the balance sheet 802 is communicated to the decision-making roles 308 via the coordinator 310. However, as people skilled in the art will acknowledge, in some instances, the balance sheet 802 is directly communicated to the decision-making roles 308.

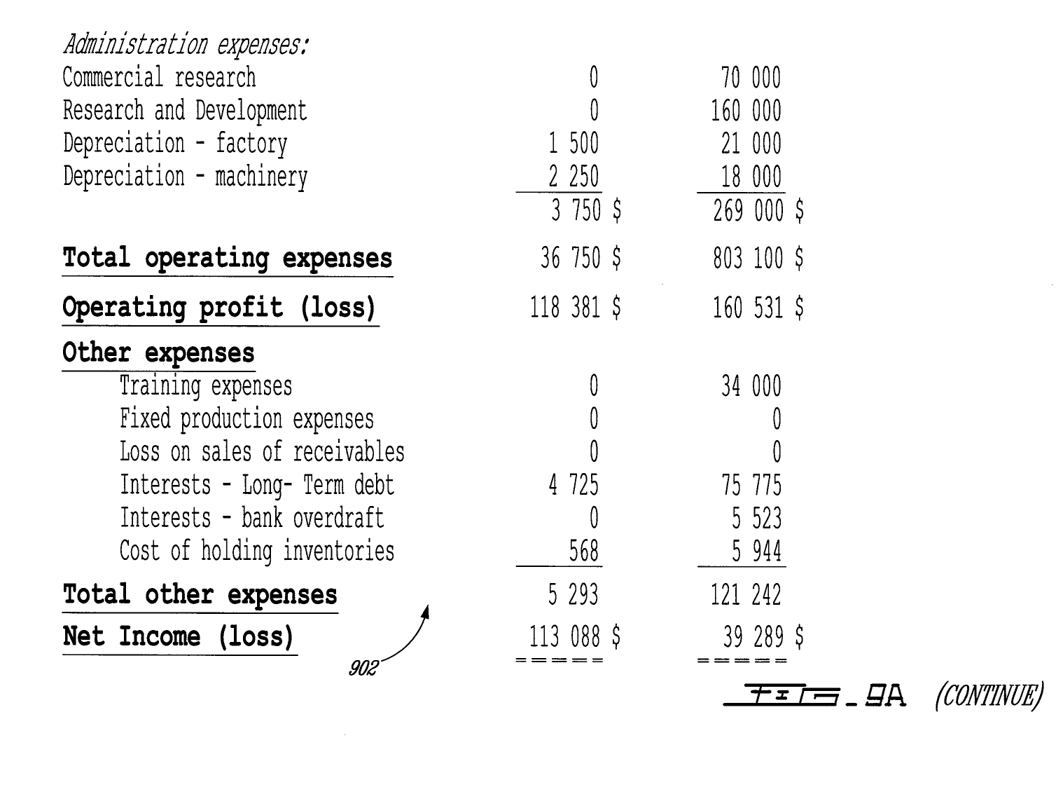

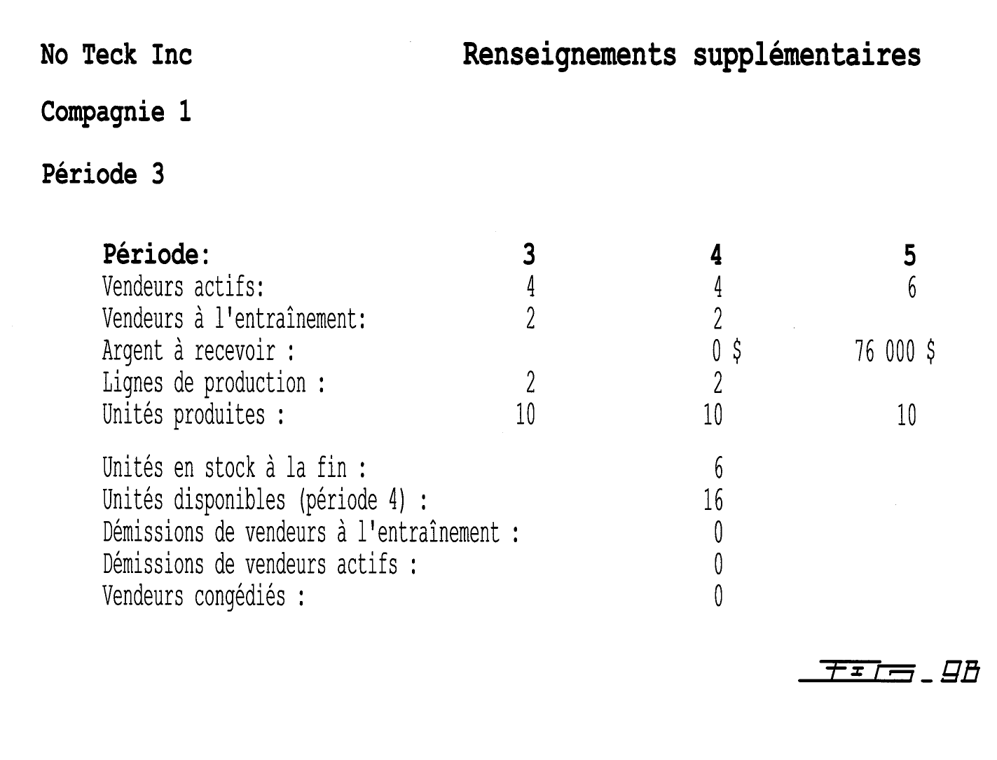

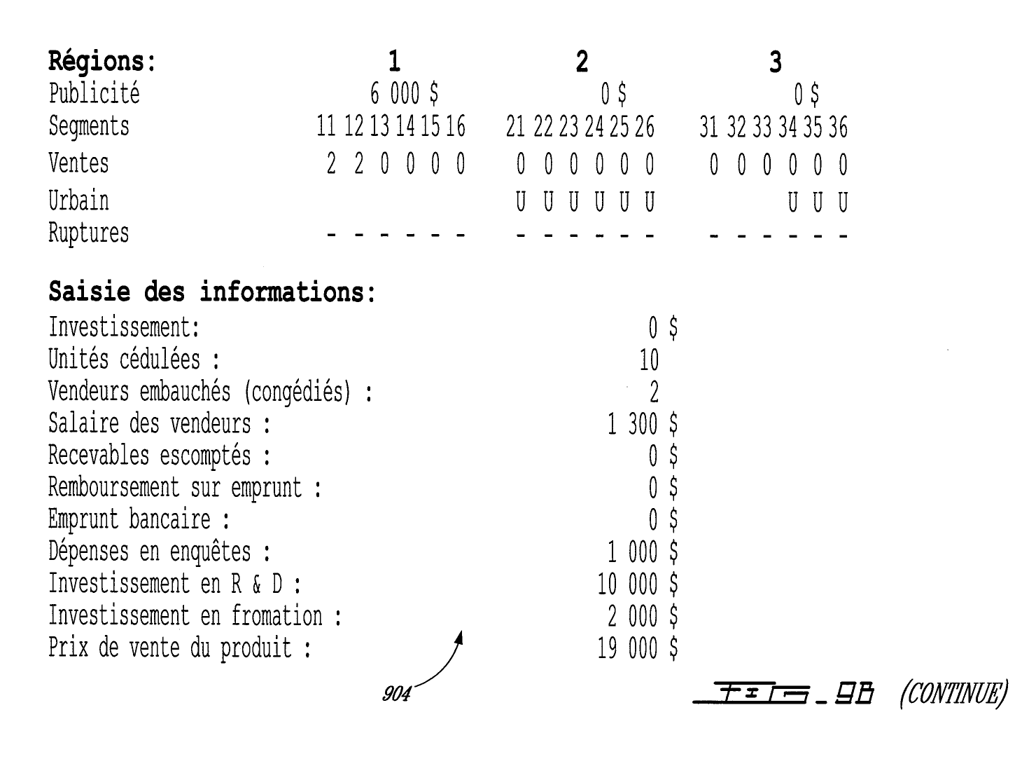

Further presented in FIG. 9a and FIG. 9b, according to an embodiment of this solution, the report generator 518 presented in FIG. 5, generates a result sheet 902 and an additional information sheet 904. The result sheet 902 describes the amount of sales, costs such as operational costs and running costs and any other selected indicators that is useful to detail for a given round. The additional information sheet 904 describes the specifics of the virtual business entity 208 with respect to man-power, to production, to publicity and to investment. In this embodiment, the result sheet 902 and additional information sheet 904 is communicated to the decision-making roles 308 via the coordinator 310, as presented in FIG. 3. However, as people skilled in the art will acknowledge, in some instances, the result sheet 902 and additional information sheet 904 is directly communicated to the decision-making roles 308.

The present method and system have been described with regard to preferred embodiments. The description as much as the drawings were intended to help the understanding of the method and system, rather than to limit its scope. It will be apparent to one skilled in the art that various modifications may be made to the solution without departing from the scope or the solution as described herein, and such modifications are intended to be covered by the present description.

1. A method allowing participants to simulate business interactions with a defined simulation context for training and evaluating business interactions in more than one politico-socio-economic environment comprising:
appointing at least one decision-making role for at least one virtual business entity to at least one participant, the decision-making role being subjected to rules corresponding to the more than one politico-socio-economic environment;
appointing at least one politico-socio-economic reference role for at least one virtual institution to at least one other participant, the politico-socio-economic reference role being subjected to rules corresponding to at least one politico-socio-economic environment;
establishing a first communication link to perform at least one business interaction between the at least one decision-making role and the at least one politico-socio-economic reference role of a first politico-socio-economic environment;
negotiating over said first communication link at least one business interaction between the at least one decision-making role and the at least one politico-socio-economic reference role by rules corresponding to said first politico-socio-economic environment;
establishing a second communication link to perform at least one business interaction between the at least one decision-making role and the at least one politico-socio-economic reference role of a second politico-socio-economic environment;
negotiating over said second communication link at least one business interaction between the at least one decision-making role and the at least one politico-socio-economic reference role by rules corresponding to said second politico-socio-economic environment;
updating decision parameter values corresponding to the conclusion of the at least one business interaction over said first communication link and second communication link between the at least one decision-making role and the at least one politico-socio-economic reference role by rules corresponding to said first politico-socio-economic environment and by rules corresponding to said second politico-socio-economic environment;
generating at least one financial report using the updated decision parameter values corresponding to the at least one business interaction of the first politico-socio-economic environment and its politico-socio-economic rules, in conjunction with the at least one business interaction of the second politico-socio-economic environment and its politico-socio-economic rules; and
reviewing of financial report for training and evaluating business interactions.

2. The method of claim 1 further comprises discovering a solution by the decision-making role that a virtual institution is capable to offer, the solution has an influence on the decision parameter values.

3. The method of claim 1 further comprises negotiating over a communication link at least one business interaction between at least two decision-making roles by rules corresponding to at least one politico-socio-economic environment, the negotiating has an influence on the decision parameter values.

4. The method of claim 1 further comprises purchasing information or a service by the business entity from a virtual institution by rules corresponding to at least one politico-socio-economic environment, the purchasing has an influence on the decision parameter values.

5. The method of claim 1 wherein said negotiating, updating and generating is repeated in multiple rounds, and wherein said reviewing is done at least at an end of the simulation.

6. The method of claim 6 wherein said reviewing is repeated in multiple rounds.

7. A method allowing participants to simulate business interactions with a defined simulation context for training and evaluating business interactions in at least one politico-socio-economic environment comprising:
identifying at least one institution that operates in the at least one politico-socio-economic environment;
appointing at least one politico-socio-economic reference role for at least one virtual institution to at least one participant, the politico-socio-economic reference role being subjected to rules and behaviors corresponding to the at least one institution that operates in the at least one politico-socio-economic environment;
appointing at least one decision-making role for at least one virtual business entity to at least one other participant, the decision-making role being subjected to rules corresponding to the at least one politico-socio-economic environment;
establishing a communication link to perform at least one business interaction between the at least one decision-making role and the at least one politico-socio-economic reference role of the at least one institution that operates in the at least one politico-socio-economic environment;
negotiating over said communication link at least one business interaction between the at least one decision-making role and the at least one politico-socio-economic reference role of the at least one institution that operates in the at least one politico-socio-economic environment;
updating decision parameter values corresponding to the conclusion of the at least one business interaction over said communication link between the at least one decision-making role and the at least one politico-socio-economic reference role of the at least one institution that operates in the at least one politico-socio-economic environment; and
generating at least one financial report using the updated decision parameter values corresponding to the at least one business interaction between the at least one decision-making role and the at least one politico-socio-economic reference role of the at least one institution that operates in the at least one politico-socio-economic environment;

8. The method of claim 7 further comprises discovering a solution by the decision-making role that a virtual institution is capable to offer, the solution has an influence on the decision parameter values.

9. The method of claim 7 further comprises negotiating over a communication link at least one business interaction between at least two decision-making roles by rules corresponding to at least one politico-socioeconomic environment, the negotiating has an influence on the decision parameter values.

10. The method of claim 7 further comprises purchasing information or a service by the business entity from a virtual institution by rules corresponding to at least one politico-socio-economic environment, the purchasing has an influence on the decision parameter values.

11. The method of claim 7 wherein said negotiating, updating and generating is repeated in multiple rounds, and wherein said reviewing is done at least at an end of the simulation.

12. The method of claim 11 wherein said reviewing is repeated in multiple rounds.
